(19) United States
(12) Patent Application Publication
(10) Pub. No.: US 2009/0080514 A1
(43) Pub. Date: Mar. 26, 2009

(54) SENDER SIDE CHANNEL ADAPTIVE VIDEO TRANSMISSION

(75) Inventor: Yingwei Chen, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,265

(22) PCT Filed: Nov. 14, 2005
(86) PCT No.: PCT/IB05/53746

§ 371 Date: May 14, 2007

Related U.S. Application Data
(60) Provisional application No. 60/628,409, filed on Nov. 16, 2004.

(51) Int. Cl. H04N 7/12

(52) U.S. Cl. 375/240.02; 375/E07.076

(57) ABSTRACT

A channel adaptive video transmission system and method. A system (10) is provided that includes: a variable length decoding system (VLD) (14) for generating header codes and discrete cosine transform (DCT) run length codes from the compressed video signal; a DCT codes marking system (16) for inserting markers into the DCT run length codes to define marked DCT coefficient segments; and a bit stream processing system (18) that determines whether to keep marked DCT coefficient segments based on current channel conditions.

The present invention relates generally to robust wireless video transmission, and relates more specifically to a system and method for implementing send side channel adaptive video transmission.

With the advent of wireless technologies, a great deal of demand has been directed toward providing wireless video streaming applications. Unfortunately, to be effective, streaming video must be able to intelligently adapt to the changing channel conditions in order to maximize video quality. Various challenges for overcoming this problem exist, which include difficulties faced due to the limited and varying capacity of the channel and the stringent bit rate and delay requirements of real-time digital video.

Existing techniques for providing channel adaptive communications include measuring the channel bandwidth through feedback of the receiver and adjusting the digital video bit rate to match the changing bandwidth using real-time transcoding. Such a system is for example provided under the tradename ViXS™. The problem with their approach is that the adaptation will always lag behind the real channel condition, as the feedback and adjusting process take time.

Another solution involves partitioning the video data into different sub-streams or layers, determining an importance of each layer, and transmitting the layers with different priorities. When the channel has sufficient throughput, all of the layers will be transmitted and received successfully. When the channel throughput drops, the more important data will get through, and the less important data will get through on a best effort basis. Using this technique, the channel adaptation takes place after the transcoding, thereby shortening the adaptation response time. Mechanisms for sensing channel conditions without specific feedback from the receiver have also been proposed. A major limitation of this solution however is that the receiver must assemble the substreams back into a single stream before it can be decoded by, e.g., a standard MPEG-2, MPEG-4, and/or H.26L decoder. This limits the applicability of this solution and potentially increases the cost of the receiver.

Accordingly, a need exists for an improved system and method for providing sender side channel adaptive video transmission.

The present invention addresses the above-mentioned problems, as well as others, by providing a channel adaptive transmission system and method. In a first aspect, the invention provides a channel adaptive transmission system for adapting a compressed video signal to a channel condition, comprising: a variable length decoding system (VLD) for generating discrete cosine transform (DCT) run length codes (and header codes) from the compressed video signal; a DCT codes marking system for inserting markers into the DCT run length codes to define marked DCT coefficient segments; and a bit stream processing system that determines whether to keep marked DCT coefficient segments based on current channel conditions.

In a second aspect, the invention provides a channel adaptive transmission method that adapts a compressed video signal to a channel condition, comprising: receiving a compressed video signal; generating discrete cosine transform (DCT) run length codes from the compressed video signal; inserting markers into the DCT run length codes to define marked DCT coefficient segments; and determining whether to keep marked DCT coefficient segments based on current channel conditions.

In a third aspect, the invention provides a program product stored on a recordable medium for adapting a compressed video signal to a channel condition, comprising: means for generating discrete cosine transform (DCT) run length codes from the compressed video signal; means for inserting markers into the DCT run length codes to define marked DCT coefficient segments; and means for determining whether to keep marked DCT coefficient segments based on current channel conditions.

In a fourth aspect, the invention provides a channel adaptive transmission system for adapting a compressed video signal to a channel condition, comprising: a variable length decoding system (VLD) for generating discrete cosine transform (DCT) run length codes comprised of blocks of DCT data from the compressed video signal; a DCT codes partitioning system for partitioning each DCT block into a pair of mini-packets identified by packet headers; and a mini-packet processing system that determines whether to keep each mini-packet based on current channel conditions.

In a fifth aspect, the invention provides a channel adaptive transmission method that adapts a compressed video signal to a channel condition, comprising: receiving a compressed video signal; generating discrete cosine transform (DCT) run length codes from the compressed video signal; partitioning each DCT block of the DCT run length codes into a first and a second mini-packet, wherein each mini-packet is identifiable from a packet header; and determining whether to keep each mini-packet based on current channel conditions.

In a sixth aspect, the invention provides a program product stored on a recordable medium for adapting a compressed video signal to a channel condition, comprising: means for receiving a compressed video signal; means for generating discrete cosine transform (DCT) run length codes from the compressed video signal; means for partitioning each DCT block of the DCT run length codes into a first and a second mini-packet, wherein each mini-packet is identifiable from a packet header; and means for determining whether to keep each mini-packet based on current channel conditions.

These and other features of this invention will be more readily understood from the following detailed description of the various aspects of the invention taken in conjunction with the accompanying drawings in which:

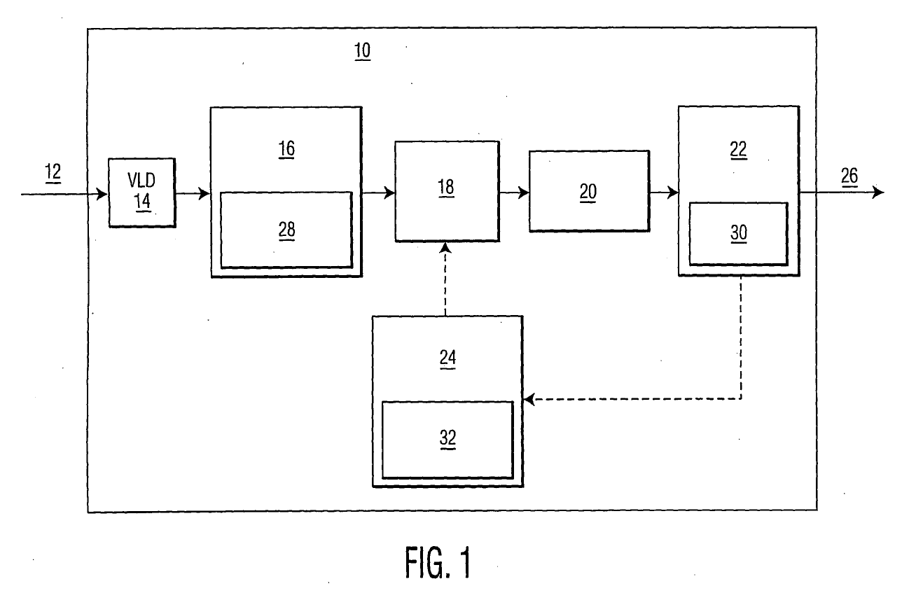

FIG. 1 depicts a block diagram of an adaptive transmission system that utilizes a bit stream marking process to provide sender side adaptation in accordance with the present invention.

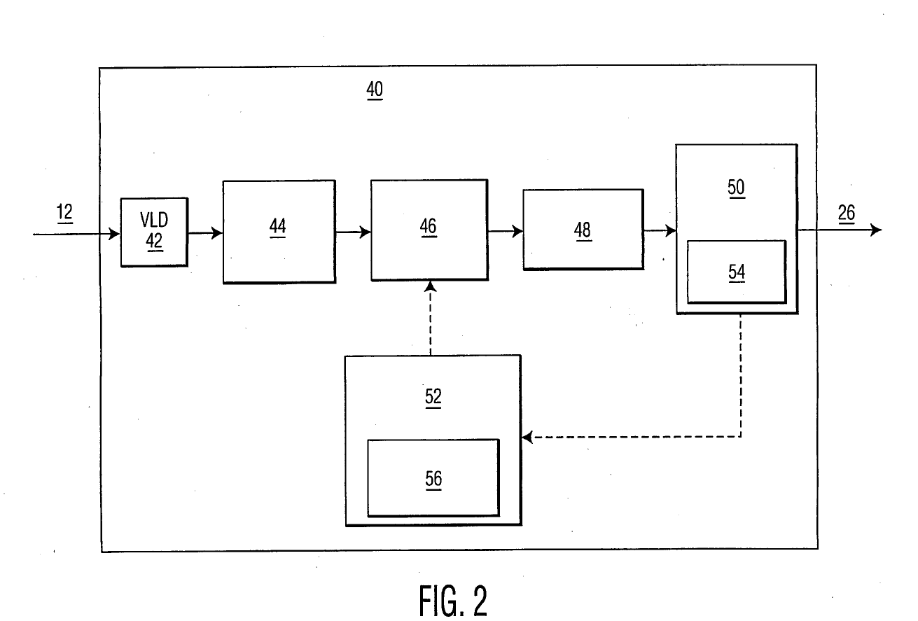

FIG. 2 depicts a block diagram of an adaptive transmission system that utilizes a mini-packetization process to provide sender side adaptation in accordance with the present invention.

The present invention provides the adaptation performance of a layered video transmission system without requiring additional demands from the receiver decoding capabilities. As described in detail below, this is achieved by providing a transmission system that merges the video layers back into one layer after channel adaptation. In this manner, the receiver can utilized a commonly deployed single layer decoder, and does not require the capability of processing multiple video layers. It should be understood that while the present invention is described with reference to a wireless system, the invention can be applied to any transmission system that must adapt to changing channel conditions.

Two illustrative embodiments are described below for implementing such a sender side adaptive transmission system. The first embodiment utilizes a bit stream marking technique to identify DCT codes that can be discarded if necessary, and the second embodiment utilizes a mini-packetization technique that partitions each DCT block into two mini-packets, each of which can be discarded if necessary.

FIG. 1 depicts a block diagram of an adaptive transmission system 10 that utilizes a bit stream marking process to provide sender side channel adaptation. In this embodiment, the compressed video stream is parsed so that “markers” can be inserted into the stream to delineate different segments. During transmission, the transmission buffer status is monitored to assess channel conditions. If the buffer is becoming too full, then certain marked segments of the bit stream can be discarded. Otherwise, only the markers will be removed.

As shown in FIG. 1, MPEG-2 video 12 enters transmission system 10, where it is initially processed by variable length decoding system (VLD) 14. It should be noted that the inputted MPEG-2 video 12 is already transcoded to a predetermined bit rate, i.e., no further transcoding is required to implement the invention. It should also be noted that while this embodiment is described with reference to processing an MPEG-2 signal, the invention can be applied to other types of compressed video signals (e.g., MPEG-4, H.26L, etc.).

VLD 14 generates a stream of header codes and discrete cosine transform (DCT) run length codes from the MPEG-2 video 12, which are then fed into DCT codes marking system 16. DCT codes marking system 16 selectively inserts uniquely identifiable markers (e.g., a string of bits) between the DCT run length codes to identify DCT coefficient segments (“segments”). The markers can for example comprise any code or set of bits that are not used by the original bit stream specification. The decision of where to insert the markers is accomplished by segmentation system 28, which may use any known or later developed technique, process and/or algorithm. For example, it may be preferable to identify higher frequency data as being expendable over lower frequency, DC data and header codes. In this case, higher frequency DCT coefficients in a string of run-length DCT codes (i.e., in each DCT block) can be marked so that they can later be readily identified and discarded if necessary.

Once this process is complete, bit stream processing system 18 either keeps or discards the next marked DCT coefficient segment based on feedback from transmission buffer control unit 24. More specifically, by examining feedback from the transmission unit 22, transmission buffer control unit 24 can determine whether the next marked segment should be discarded in order to maintain a desirable fullness in the buffer 30. For example, transmission buffer control unit 24 may look to see if a predetermined fullness threshold 32 (e.g., 75%) of the buffer 30 has been exceeded. If it has been exceeded, transmission buffer control unit 24 can signal bit stream processing system 18 to discard the next marked DCT coefficient segment. Marked segments can be discarded as necessary until the buffer fullness falls below the fullness threshold 32.

If the signal from the transmission control buffer unit 24 is to discard the next marked DCT coefficient segment, then bit stream processing system 18 discards the bits starting at a beginning marker (marking the beginning of the segment) to an end marker (marking the end of the segment), inclusive of the markers themselves. If the control signal from the transmission control buffer unit 24 is to keep the next marked segment intact, then only the markers are removed.

After bit stream processing system 18 completes its processing, the bit stream is packetized by packetization system 20 to generate an adapted video signal, which can then be transmitted over channel 26 by transmission unit 22. It should be understood that the process of examining the buffer 30 to ascertain and react to channel conditions described above has been provided for illustrative purposes only, and that any other process that assesses channel conditions and removes or causes removal of marked DCT coefficient segments from the bit stream based on channel conditions falls within the scope of this invention.

A second embodiment of the invention is described in FIG. 2. In this embodiment, rather than inserting unique bits to mark segments in order to, e.g., identify higher frequency DCT coefficients, each DCT block is partitioned into two or more “mini-packets” identified by packet headers. The mini-packets are then either discarded or kept based on a signal from the transmission buffer control unit 52.

Thus, similar to the first embodiment described above, adaptive transmission system 40 includes VLD 42 that receives a compressed video signal, MPEG-2 video 12, and generates DCT run length codes. The codes are partitioned by DCT codes partitioning system 44, which breaks each DCT block into two or more mini-packets. In general, the first mini packets are more valuable than the later ones. In addition, more than two mini-packets per block can be partitioned for finer-granularity differentiation among data.

Mini-packet processing system 46 then either keeps or discards the next mini-packet based on a signal from the transmission buffer control unit 52. Transmission buffer control unit 52 decides whether to keep or discard the next mini-packet using, for instance, the same process described above for the first embodiment. That is, if the fullness of the buffer 54 is above a predetermined fullness threshold 56, then transmission buffer control unit 52 signals to mini-packet processing system 46 to discard the next mini-packet.

After processing by mini-packet processing system 46, the resulting mini-packets are packetized by packetization system 48 to generate an adapted video signal, which can then be transmitted by transmission unit 50. It should be understood that the process of examining the buffer 54 to ascertain and react to channel conditions described above has been provided for illustrative purposes only, and that any other process that assesses channel conditions and removes or causes removal of mini-packets from the bit stream based on channel conditions falls within the scope of this invention.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A channel adaptive transmission system (10) for adapting a compressed video signal (12) to a channel condition, comprising:
a variable length decoding system (VLD) (14) for generating discrete cosine transform (DCT) run length codes from the compressed video signal;
a DCT codes marking system (16) for inserting markers into the DCT run length codes to define marked DCT coefficient segments; and
a bit stream processing system (18) that determines whether to keep marked DCT coefficient segments based on current channel conditions.

2. The channel adaptive transmission system of claim 1, further comprising a transmission buffer control unit (24) that determines channel conditions by comparing a fullness of a transmission buffer (30) with a fullness threshold value (32).

3. The channel adaptive transmission system of claim 2, wherein the transmission buffer control unit signals the bit stream processing system to discard a next marked DCT coefficient segment if the fullness of the transmission buffer exceeds the fullness threshold value.

4. The channel adaptive transmission system of claim 1, further comprising:
a packetization system (20) for packetizing the output of the bit stream processing system into an adapted video signal; and
a transmission unit (22) for outputting the adapted video signal.

5. The channel adaptive transmission system of claim 1, wherein the DCT codes marking system includes a segmentation system for identifying and marking high frequency DCT coefficient segments.

6. A channel adaptive transmission method that adapts a compressed video signal to a channel condition, comprising:
receiving a compressed video signal;
generating (14) discrete cosine transform (DCT) run length codes from the compressed video signal;
inserting (16) markers into the DCT run length codes to define marked DCT coefficient segments; and
determining (18) whether to keep marked DCT coefficient segments based on current channel conditions.

7. The method of claim 6, wherein channel conditions are determined by comparing a fullness of a transmission buffer with a fullness threshold value.

8. The method of claim 7, wherein a next marked DCT coefficient segment is discarded if the fullness of the transmission buffer exceeds the fullness threshold value.

9. The method of claim 6, further comprising the steps of:
packetizing the resulting bit stream into an adapted video signal; and
outputting the adapted video signal.

10. The method of claim 6, wherein the inserting step includes the step of identifying and marking high frequency DCT coefficient segments.

11. A program product stored on a recordable medium for adapting a compressed video signal to a channel condition, comprising:
means (14) for generating discrete cosine transform (DCT) run length codes from the compressed video signal;
means (16) for inserting markers into the DCT run length codes to define marked DCT coefficient segments; and
means (18) for determining whether to keep marked DCT coefficient segments based on current channel conditions.

12. A channel adaptive transmission system (40) for adapting a compressed video signal (12) to a channel condition, comprising:
a variable length decoding system (VLD) (42) for generating discrete cosine transform (DCT) run length codes comprised of blocks of DCT data from the compressed video signal;
a DCT codes partitioning system (44) for partitioning each DCT block into a pair of mini-packets identified by packet headers; and
a mini-packet processing system (46) that determines whether to keep each mini-packet based on current channel conditions.

13. The channel adaptive transmission system of claim 12, further comprising a transmission buffer control unit (52) that determines channel conditions by comparing a fullness of a transmission buffer (54) with a fullness threshold value (56).

14. The channel adaptive transmission system of claim 13, wherein the transmission buffer control unit signals the mini-packet processing system to discard a next mini-packet if the fullness of the transmission buffer exceeds the fullness threshold value.

15. The channel adaptive transmission system of claim 12, further comprising:
a packetization system (48) for packetizing the output of the mini-packet processing system into an adapted video signal; and
a transmission unit (50) for outputting the adapted video signal.

16. The channel adaptive transmission system of claim 12, wherein the DCT codes marking system includes a segmentation system (28) for identifying and marking high mini-packets containing high frequency coefficients.

17. A channel adaptive transmission method that adapts a compressed video signal to a channel condition, comprising:
receiving a compressed video signal;
generating (44) discrete cosine transform (DCT) run length codes from the compressed video signal;
partitioning (46) each DCT block of the DCT run length codes into a first and a second mini-packet, wherein each mini-packet is identifiable from a packet header; and
determining (48) whether to keep each mini-packet based on current channel conditions.

18. The method of claim 17, wherein channel conditions are determined by comparing a fullness of a transmission buffer (54) with a fullness threshold value (56).

19. The method of claim 18, wherein a next mini-packet is discarded if the fullness of the transmission buffer exceeds the fullness threshold value.

20. The method of claim 17, further comprising the steps of:
packetizing (48) the resulting bit stream into an adapted video signal; and
outputting the adapted video signal.

21. The method of claim 17, wherein the partitioning step includes the step of identifying and marking mini-packets containing high frequency DCT coefficients.

22. A program product stored on a recordable medium for adapting a compressed video signal to a channel condition, comprising:
means (40) for receiving a compressed video signal;
means (42) for generating discrete cosine transform (DCT) run length codes from the compressed video signal;
means (44) for partitioning each DCT block of the DCT run length codes into a first and a second mini-packet, wherein each mini-packet is identifiable from a packet header; and
means (46) for determining whether to keep each mini-packet based on current channel conditions.
